(19) United States
(12) Patent Application Publication
(10) Pub. No.: US 2003/0213564 A1
(43) Pub. Date: Nov. 20, 2003

(54) Roller screen housing for a folding window

(76) Inventor: Glen Douglas Pacholke, Eatons Hill (AU)

Correspondence Address: WELLS ST. JOHN P.S., 601 W. FIRST AVENUE, SUITE 1300, SPOKANE, WA, 99201, US

(21) Appl. No.: 10/437,647

(22) Filed: May 13, 2003

(30) Foreign Application Priority Data
May 15, 2002 (AU) PS 2332

(51) Int. Cl. E06B 3/32

(52) U.S. Cl. 160/98

(57) ABSTRACT

A roller screen housing for a folding window is formed as a single metal extrusion having a track portion (13) of inverted U-shaped section and a roller housing portion (23) of C-shaped section connected at the back thereof to a web of the track section. The track (13) is adapted to suspend window panels (18), and the roller housing houses a screen roller (21).

This invention relates to a roller screen housing for a window frame. In particular, the invention is directed to an extruded section for use at the head of a folding window, which provides both a track for the folding window panels and a housing for a roller screen.

### BACKGROUND ART

Folding windows possess several advantages over other types of window constructions such as sliding windows, hinged windows, and sash windows. For example, folding windows can be folded completely to one or both sides of the window frame, leaving virtually all of the window space open and unobstructed. This not only provides an unimpeded view through the window, but maximises the amount of breeze captured by the window.

Folding windows typically comprise a plurality of hinged window panels suspended from a track fixed to the head of the window frame. An adjacent pair of hinged panels can be suspended from the track by a single combined carrier hinge, such as the carrier hinge described in Australian patent no. 726943. The carrier hinge comprises a carriage adapted to travel along the track, and a hinge suspended from the track by its hinge pin. The carriage typically has at least one pair of co-axial wheels which ride in respective spaced channels formed in the track. The adjacent panels are edge-fixed to a respective leaf of the hinge. The carrier hinge enables the hinged panels to travel along the track and pivot about a vertical hinge axis.

In some locations where insects are a problem, it is necessary or desirable to provide insect screens on windows. Hitherto, insect screens have not been used widely on folding windows, due to difficulties in mounting the screens across the wide spans of folding windows. Moreover, the fixed mounting of screens to folding windows negates the advantage of a large unimpeded space which a folding window would otherwise provide.

Roller or roll-up insect screens are known. Such screens may be self-contained assemblies which are fixed to one side of a window frame, or they may comprise separate roller and screen components which are mounted onto the window frame. In roller screens, the screen mesh is typically rolled up on a spring-loaded roller located at the top of the window opening. The screen can be selectively closed by pulling the screen mesh down so that it unwinds from the roller against its bias, or opened by allowing it to self-furl onto the roller.

However, as the roller is usually mounted below the window head, it remains clearly visible even when furled, and detracts from the appearance of the window. Even if the roller is housed in a channel section or similar box housing, the housing remains visible and reduces the open area of the window frame.

The roller screen housing also adds to the total cost of the window installation.

It is an object of this invention to provide a roller screen housing, particularly for a folding window, which overcomes or ameliorates one or more of the above described disadvantages, or which at least provides the consumer with a useful choice.

### SUMMARY OF THE INVENTION

In one broad form, the invention provides a window having a horizontal track, a plurality of hinged window panels suspended from the track, the panels being adapted to fold open and close, and an elongate housing for a roller screen, the roller screen housing extending alongside the track, wherein the track and the roller screen housing are integrally formed as a unipartite extruded section.

In another form, the invention provides a building component for placement at the head of a window, the component comprising a track, and an elongate housing for a roller screen, the roller screen housing extending alongside the track, wherein the track and the roller screen housing are integrally formed as a unipartite extruded section.

Typically, the window has a frame including an elongate head member, and the extruded section is mounted under the head member.

Preferably, the track has an inverted U-shaped section, and the roller screen housing has a C-shaped section, joined at the back thereof to a web of the U-shaped track section. The roller screen housing may have a curved lower lip on its C-shaped section. A roller may be rotatably mounted in the roller screen housing, and a screen wound on the roller, the screen being draped over the curved lower lip in use.

Preferably, the roller screen housing does not extend below the track.

The extruded section is typically made principally of aluminium.

The term “screen” as used in this specification is intended to include not only insect screens, but also solar screens, blinds, shades and similar flexible roll-up screening material.

In order that the invention may be more fully understood and put into practice, a preferred embodiment thereof will now be described with reference to the accompanying drawings.

### BRIEF DESCRIPTION OF THE DRAWINGS

FIG. 1 is a fragmentary sectional perspective view of a roller screen housing for a window, according to one embodiment of the invention.

FIG. 2 is a sectional elevation of a folding window having the roller screen housing of FIG. 1, with the roller screen in its retracted (open) position.

FIG. 3 is a sectional elevation of the folding window of FIG. 2, with the roller screen in its extended (closed) position.

### DESCRIPTION OF PREFERRED EMBODIMENT

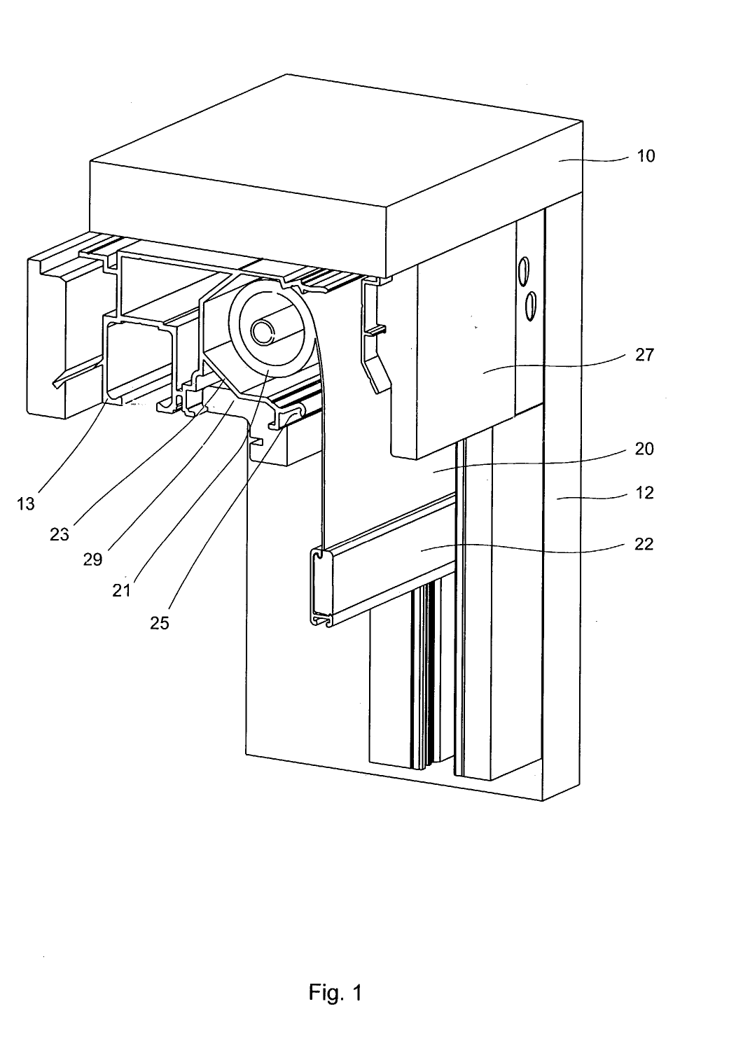

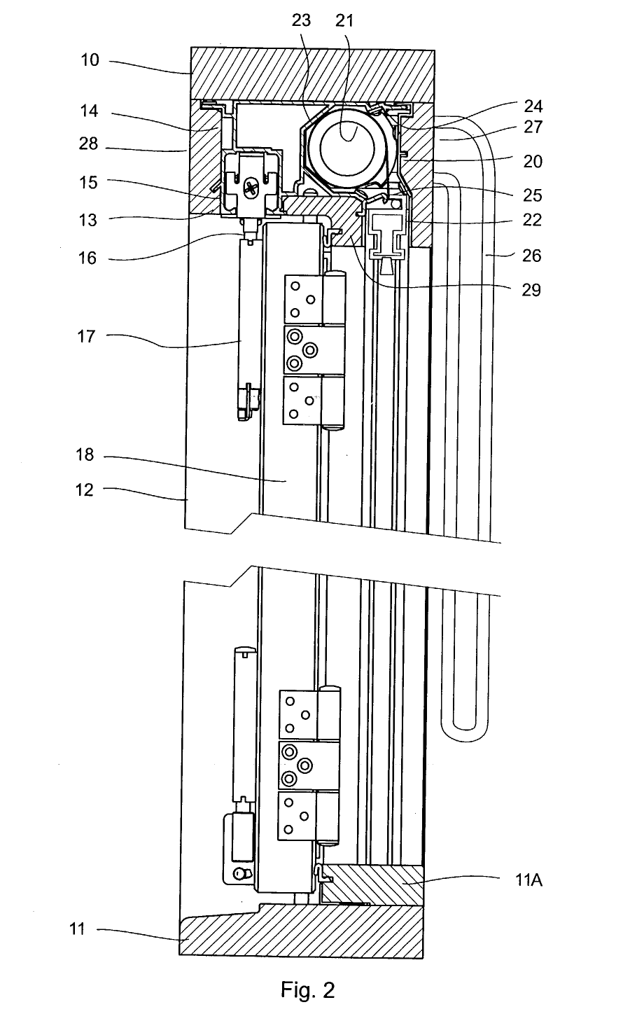

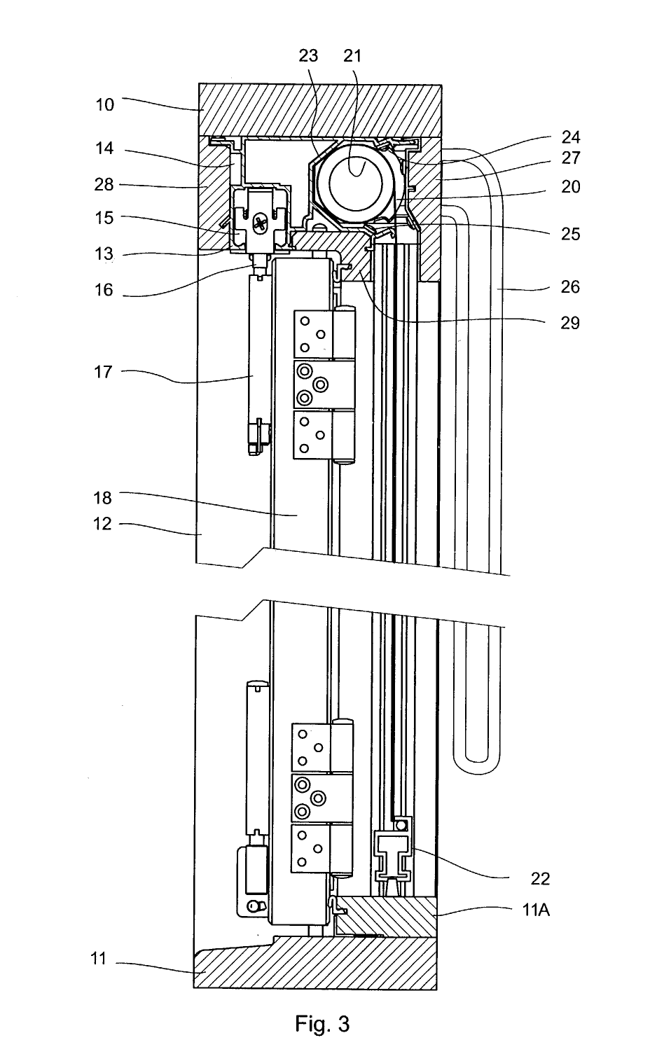

FIGS. 1-3 illustrate a folding window according to one embodiment of this invention. The window has a frame formed by a head 10, a sill 11, and jambs 12 located on opposite sides of the window and extending between the head and the sill. The frame components may be made of wood, or other suitable material such as extruded metal section.

A track 13 is fixed to the underside of the head 10 by screws 14. A carrier hinge (omitted from FIG. 1 for clarity) is used to suspend adjacent hinged panels from the track. The carrier hinge comprises a carriage 15 adapted to travel along the track 13. A hinge pin 16 is threaded into the carriage, and depends from the carriage. Hinge leaves 17 are pivotally mounted to the hinge pin 16, and are fixed to opposed edge faces of respective adjacent window panels 18. The carrier hinge may be of the type described in Australian patent no. 726943.

A hanger may be used to suspend the first panel, i.e. the window panel nearest the jamb, while permitting the first panel to pivot. As such carrier hinges and hangers are known in the art, they are not described in detail in this specification.

A roll-up screen 20 is provided on the window. The screen 20 is a flexible sheet, typically of woven mesh, and can be furled onto a roller 21. The bottom edge of the screen 20 is attached to a horizontal rod or bar 22 spanning across the window. The vertical edges of the screen 20 may suitably be received in guide channels provided in the jambs of the window.

The screen roller 21 is housed in a housing 23 generally of channel section. The roller housing 23 is fixed to the head 10 by screws 24 inserted through the top leg or side of the channel section. The bottom leg or side of the channel section is provided with a rounded edge 25 over which the screen 20 slides as it is opened and closed.

The screen 20 is of the holland blind type, and an endless cord 26 is provided to enable a user to rotate the screen roller 21 and thereby open or close the screen. For large span screens, a spring bias may be provided in the screen roller 21 to counteract the weight of the screen.

For aesthetic purposes, inner and outer pelmets 27, 28 may be provided and fixed to the head 10 in any suitable manner. A spacer 29, typically in the form of a timber moulding, is suitably provided between the roller housing 23 and the track 13.

A particularly advantageous feature of the illustrated embodiment is that the track 13 and roller housing 23 are formed as a unipartite member, such as a single aluminium extrusion. The extrusion is designed to position the roller housing channel 23 so it does not protrude below the track 13.

The integrated track and roller screen housing has several advantages, including:

(i) By forming the track 13 and roller housing 23 as a single extrusion, the roller housing is maintained in fixed relationship to the track 13.

(ii) By combining the track 13 and the roller housing 23 in a single extrusion, the extrusion provides strength and rigidity to the window head, which is particularly advantageous in large span windows.

(iii) As the channel housing 23 does not protrude below the track 13, it is not visible, and does not obstruct or intrude upon the otherwise clear space of the window opening when the window is folded open.

(iv) The combined track and channel housing can be designed to serve as the head of the window frame.

(v) Although the track and channel housing are maintained in a fixed relationship, the extrusion can accommodate window panels 18 of different thickness. All that needs to be changed is the width of the spacer 29, and the window stop 11A.

(vi) As the track 13 and channel housing 23 are formed as a single extrusion, manufacturing costs are reduced. Moreover, installation time and costs are also reduced.

(vii) The window can be assembled without the roller, and the screen can be easily inserted later if desired.

The foregoing describes only one embodiment of the invention, and modifications which are obvious to those skilled in the art may be made thereto without departing from the scope of the invention as defined in the following claims.

For example, although the illustrated folding window is an outward opening window (i.e. the window panels fold to the outside of the centre plane of the window), the invention can be adapted, which suitable modification, for use with inward opening panels with the screen on the outside of the window panels.

The roller housing of this invention is particularly suitable for folding windows, but it may also be used with other window types if desired.

1. A window having
a horizontal track,
a plurality of hinged window panels suspended from the track, the panels being adapted to fold open and close, and
an elongate housing for a roller screen, the roller screen housing extending alongside the track,
wherein the track and the roller screen housing are integrally formed as a unipartite extruded section.

2. A window as claimed in claim 1, wherein the window has a frame including an elongate head member, and the extruded section is mounted under the head member.

3. A window as claimed in claim 2, wherein the track has an inverted U-shaped section, and the roller screen housing has a C-shaped section, joined at the back therof to a web of the U-shaped track section.

4. A window as claimed in claim 3, wherein the roller screen housing has a curved lower lip on its C-shaped section.

5. A window as claimed in claim 4, further comprising a roller rotatably mounted in the roller screen housing, and a screen wound on the roller, the screen being draped over the curved lower lip.

6. A window as claimed in claim 4, further comprising an elongate spacer member fitted to the extruded section between the lower lip and the track section.

7. A window as claimed in claim 1, wherein the roller screen housing does not extend below the track.

8. A window as claimed in claim 7, wherein the extruded section is made principally of aluminium.

9. A building component for placement at the head of a window, the component comprising
a track, and
an elongate housing for a roller screen, the roller screen housing extending alongside the track,
wherein the track and the roller screen housing are integrally formed as a unipartite extruded section.

10. A building component as claimed in claim 9, wherein the track has an inverted U-shaped section, and the roller screen housing has a C-shaped section, joined at the back thereof to a web of the U-shaped track section.

11. A building component as claimed in claim 10, wherein the roller screen housing has a curved lower lip on the C-shaped section.

12. A building component as claimed in claim 11, further comprising a roller rotatably mounted in the roller screen housing, and a screen wound on the roller, the screen being draped over the curved lower lip.

13. A building component as claimed in claim 11, further comprising an elongate spacer member fitted to the extruded section between the lower lip and the track section.

14. A building component as claimed in claim 10, wherein the extruded section is made principally of aluminium.

15. A roller screen housing for a window, the housing being a unipartite extruded metal section having a roller screen portion adapted to house a roller screen, and a track portion integrally formed with the roller screen portion.

16. A roller screen housing as claimed in claim 15, wherein the track portion is an inverted U-shaped section, and the roller screen portion is a C-shaped section joined at the back thereof to a web of the U-shaped section.

17. A roller screen housing as claimed in claim 16, wherein the C-shaped section of the roller screen portion has a curved lower lip.
